(19) United States
(12) Patent Application Publication
(10) Pub. No.: US 2026/0134442 A1
(43) Pub. Date: May 14, 2026

(54) CROSS-BORDER ARTIFICIAL INTELLIGENCE COMPLIANCE AND SOVEREIGNTY SYSTEM

(71) Applicant: George William Bickerstaff, III, Greenwich, CT (US)

(72) Inventor: George William Bickerstaff, III, Greenwich, CT (US)

(21) Appl. No.: 19/444,088

(22) Filed: Jan. 8, 2026

(51) Int. Cl. G06Q 30/018; G06N 20/00

(52) U.S. Cl. CPC G06Q 30/018; G06N 20/00

(57) ABSTRACT

A cross-border artificial intelligence compliance and sovereignty system is disclosed that dynamically enforces jurisdiction-specific legal and regulatory constraints on artificial intelligence behavior. The system detects jurisdiction context, resolves conflicting sovereignty requirements, intercepts and adapts execution behavior in real time, and generates machine-verifiable audit artifacts, enabling scalable global deployment of artificial intelligence systems.

### TECHNICAL FIELD

The present invention relates to artificial intelligence systems operating across multiple jurisdictions and, more particularly, to technical systems and methods for dynamically enforcing jurisdiction-specific legal, regulatory, and sovereignty constraints on artificial intelligence behavior during execution.

### BACKGROUND

Artificial intelligence systems are increasingly deployed across national borders, cloud regions, and distributed infrastructures. Such deployments expose organizations to fragmented and sometimes conflicting legal requirements related to data residency, privacy, export controls, sector-specific regulations, and national sovereignty rules. Existing compliance approaches rely on static configurations, manual controls, or regional system segregation, which are inefficient, brittle, and error-prone.

As artificial intelligence systems operate dynamically across geographies, jurisdictional context may change during execution, resulting in unintended violations of local laws or sovereignty requirements. The absence of a technical mechanism to adapt artificial intelligence behavior in real time based on jurisdictional constraints limits global scalability and increases regulatory risk. There is therefore a need for a technical system that dynamically enforces cross-border compliance and sovereignty constraints at execution time within artificial intelligence systems.

### SUMMARY OF THE INVENTION

The invention provides a cross-border artificial intelligence compliance and sovereignty system configured to dynamically determine applicable jurisdictional requirements and enforce corresponding constraints on artificial intelligence behavior in real time. The system detects jurisdictional context, retrieves and evaluates applicable compliance rules, resolves conflicts between overlapping sovereignty requirements, and intercepts and adapts execution behavior accordingly.

The system further enforces data residency, export control, and localization requirements while generating machine-verifiable audit artifacts demonstrating compliance across jurisdictions. By embedding sovereignty enforcement directly into execution pathways, the invention enables scalable global deployment of artificial intelligence systems without manual reconfiguration.

### Definitions

### Compliance Rule

A machine-executable constraint derived from a jurisdictional legal or regulatory requirement.

### Cross-Border Audit Artifact

A machine-readable record demonstrating enforcement of jurisdiction-specific compliance during artificial intelligence execution.

### Data Residency Constraint

A limitation governing where data may be stored, processed, or transferred.

### Execution Adaptation

A modification of artificial intelligence system behavior based on jurisdiction context.

### Export Control Requirement

A restriction on cross-border transfer of data, models, or outputs.

### Jurisdiction Context

A set of geographic, legal, and regulatory attributes applicable to an execution environment.

### Localization Policy

A rule requiring localized processing, storage, or execution within a specific territory.

### Rule Conflict

An incompatibility between two or more jurisdictional compliance rules.

### Sovereignty Constraint

A jurisdiction-imposed requirement governing artificial intelligence operation.

### Territorial Detection Engine

A system component configured to determine jurisdiction context during execution.

### BRIEF DESCRIPTION OF THE DRAWINGS

FIG. 1 illustrates jurisdiction detection architecture.

FIG. 2 illustrates sovereignty constraint selection and conflict resolution.

FIG. 3 illustrates execution behavior interception and adaptation.

FIG. 4 illustrates data residency and export control enforcement.

FIG. 5 illustrates cross-border audit and reporting.

### DETAILED DESCRIPTION OF THE INVENTION

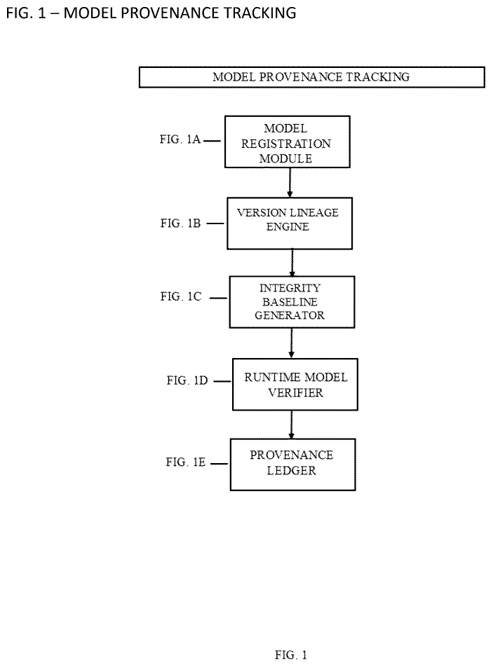

### FIG. 1—Jurisdiction Detection Architecture

### FIG. 1A—Territorial Signal Intake Module

Geographic, network, and infrastructure signals are ingested from execution environments. Signals may include location metadata and routing information. Inputs are validated for authenticity.

### FIG. 1B—Jurisdiction Inference Engine

Territorial signals are analyzed to infer applicable jurisdictions. Multiple jurisdictions may be inferred simultaneously. Inference confidence values are generated.

### FIG. 1C—Jurisdiction Context Builder

Inferred jurisdictions are assembled into a jurisdiction context including legal domains and regulatory scopes. Contexts are versioned per execution.

### FIG. 1D—Continuous Context Monitor

Jurisdiction context is monitored during execution. Changes in execution location trigger re-evaluation. Updates propagate dynamically.

FIG. 1eE—Jurisdiction Snapshot Recorder

Jurisdiction determinations are recorded in a tamper-evident manner. Snapshots preserve temporal ordering and support audit.

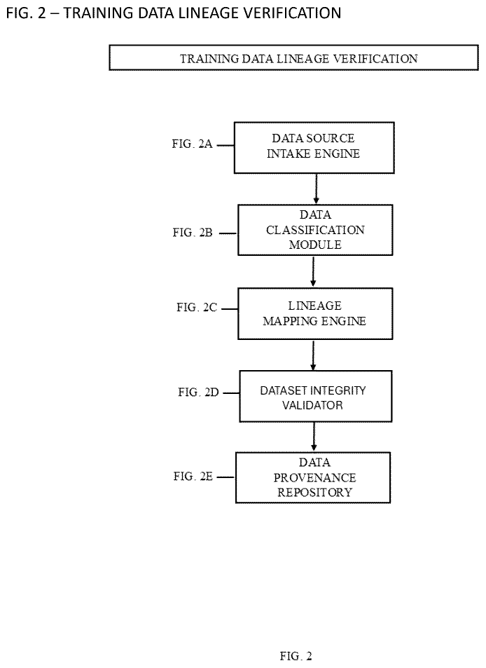

### FIG. 2—Sovereignty Constraint Selection and Conflict Resolution

### FIG. 2A—Rule Retrieval Engine

Compliance rules applicable to detected jurisdictions are retrieved. Rules are indexed by domain and territory.

### FIG. 2B—Sovereignty Constraint Mapper

Jurisdiction-specific sovereignty constraints are identified and normalized. Localization and control requirements are mapped.

### FIG. 2C—Rule Conflict Detection Module

Overlapping rules are evaluated for incompatibility. Conflict severity is classified.

### FIG. 2D—Conflict Resolution Engine

Resolution logic prioritizes stricter or mandatory constraints. Conservative enforcement strategies may be applied. Decisions are recorded.

### FIG. 2E—Applicable Rule Set Generator

A final machine-executable rule set data structure governing execution behavior is generated and versioned. The rule set is configured for real-time evaluation during execution interception.

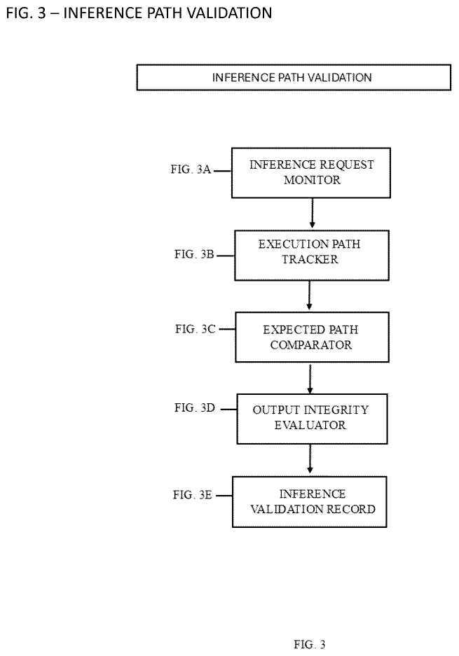

### FIG. 3—Execution Behavior Interception and Adaptation

### FIG. 3A—Execution Interception Gate

Proposed artificial intelligence actions are intercepted prior to execution. Jurisdiction-aware evaluation is initiated synchronously.

### FIG. 3B—Behavior Modification Engine

Actions are modified to comply with applicable sovereignty constraints, including parameter adjustment or execution relocation.

### FIG. 3C—Conditional Execution Router

Execution paths are selected based on compliance constraints. Routing decisions are logged.

### FIG. 3D—Escalation and Blocking Module

Non-compliant actions are escalated or blocked. Escalations may route to human review.

### FIG. 3E—Execution Outcome Recorder

Final execution outcomes and applied constraints are recorded for audit.

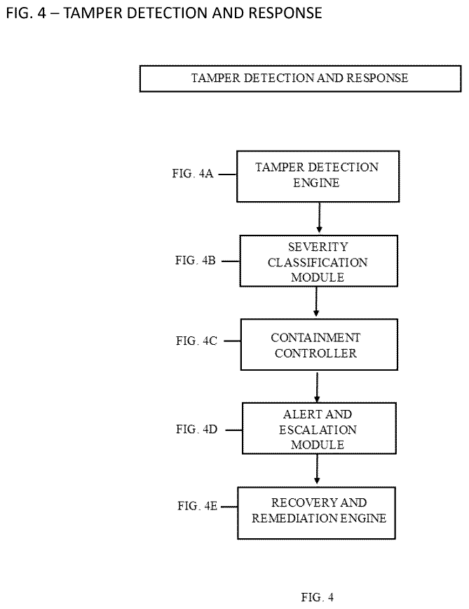

### FIG. 4—Data Residency and Export Control Enforcement

### FIG. 4A—Data Classification Engine

Data is classified by sensitivity and jurisdictional relevance.

FIG. 4B—Residency Enforcement Module

Data storage and processing locations are enforced in real time.

### FIG. 4C—Export Control Evaluator

Cross-border transfers are evaluated against export control requirements.

FIG. 4D—Localization Execution Manager

Localized execution environments are selected where required.

### FIG. 4E—Cross-border Transfer Logger

All transfers and decisions are logged immutably.

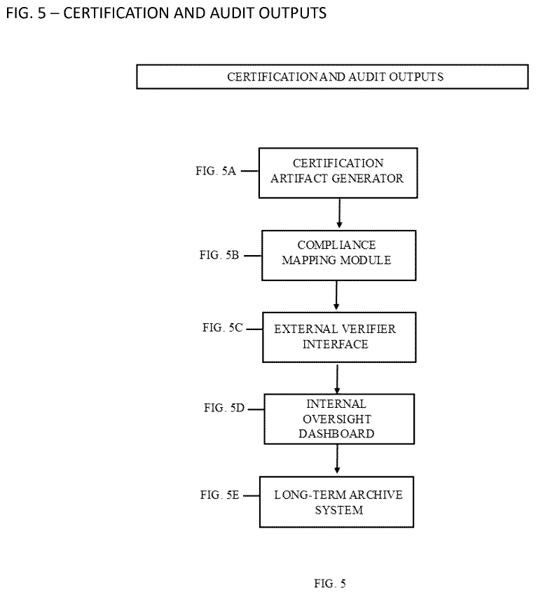

### FIG. 5—Cross-Border Audit and Reporting

### FIG. 5A—Compliance Evidence Generator

Machine-readable compliance evidence is generated per execution.

FIG. 5B—Jurisdiction-Specific Reporting Formatter

Reports are formatted according to jurisdictional requirements.

FIG. 5C—Regulator Interface Connector

Secure interfaces deliver compliance reports.

FIG. 5D—Internal Oversight Dashboard

Cross-border compliance status is displayed in real time.

### FIG. 5E—Long-term Compliance Archive

Audit artifacts are archived securely for review and litigation.

### Illustrative Operational Example (Non-Limiting)

In one non-limiting example, an artificial intelligence system executes across multiple cloud regions. Territorial signals are ingested and analyzed to determine that multiple jurisdictions apply simultaneously. Applicable compliance rules are retrieved, normalized, resolved for conflict, and compiled into a machine-executable rule set.

During execution, a proposed action is intercepted and evaluated against the rule set. The behavior modification engine determines that localized processing is required and redirects execution to a compliant regional environment. A subsequent attempted cross-border transfer is evaluated against export control requirements and is blocked.

Following execution, a cross-border audit artifact is generated documenting jurisdiction context, applied constraints, execution adaptations, and enforcement actions. The artifact is archived and made available for internal oversight and regulatory reporting.

1. A cross-border artificial intelligence compliance system, comprising:
a jurisdiction detection engine configured to determine applicable jurisdictions during execution;
a sovereignty constraint selector configured to generate executable compliance rules based on the determined jurisdictions; and
an execution interception and adaptation layer configured to intercept, modify, or block artificial intelligence actions in real time based on said rules.

2. A method for enforcing jurisdiction-specific compliance, comprising:
detecting a jurisdiction context during artificial intelligence execution;
selecting applicable sovereignty constraints;
evaluating proposed actions against the constraints; and
adapting execution behavior accordingly.

3. A non-transitory computer-readable medium storing instructions that, when executed, cause a system to dynamically enforce cross-border compliance for artificial intelligence operations.

4. The system of claim 1, wherein data residency constraints are enforced in real time.

5. The method of claim 2, wherein conflicting jurisdictional requirements are resolved conservatively.

6. The system of claim 1, further comprising export control enforcement.

7. The method of claim 2, wherein execution behavior is dynamically rerouted.

8. The system of claim 1, wherein non-compliant actions are escalated to human review.

9. The computer-readable medium of claim 3, wherein compliance artifacts are generated automatically.

10. The system of claim 1, wherein jurisdiction context is continuously monitored.
